(19) United States
(12) Patent Application Publication
(10) Pub. No.: US 2008/0074746 A1
(43) Pub. Date: Mar. 27, 2008

(54) Optical System For Converting A Primary Intensity Distribution Into A Predefined Intensity Distribution That Is Dependent On A Solid Angle

(76) Inventor: Matthias Cumme, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/632,367

(22) PCT Filed: Jul. 15, 2005
(86) PCT No.: PCT/DE05/01268

§ 371 Date: Jan. 12, 2007

(30) Foreign Application Priority Data
Jul. 19, 2004 (DE) 10 2004 035 489.8

(51) Int. Cl. G02B 27/46

(52) U.S. Cl. 359/562

(57) ABSTRACT

It is the object of an optical system and a method for converting a primary intensity distribution into a predetermined intensity distribution dependent on a solid angle to reduce the disruptive influence of the zeroth diffraction order beyond the limits imposed by the manufacturing accuracy in the manufacture of the diffractive structures, also with increasingly higher apertures, while making use of the advantages of diffractive structures in providing variously shaped intensity distributions. In a first plane, in which first micro-optic homogenization structures generate a finely structured amplitude distribution and phase distribution from the primary intensity distribution, there are arranged second diffractive micro-optic homogenization structures which are adapted to the finely structured amplitude distribution and phase distribution and which generate the predetermined solid angle-dependent intensity distribution in a second plane from the finely structured amplitude distribution and phase distribution.

### CROSS-REFERENCE TO RELATED APPLICATIONS

This application claims priority of International Application No. PCT/DE2005/001268, filed Jul. 15, 2005 and German Application No. 10 2004 035 489.8, filed Jul. 19, 2004, the complete disclosures of which are hereby incorporated by reference.

### BACKGROUND OF THE INVENTION

a) Field of the Invention

The invention is directed to an optical system for converting a primary intensity distribution into a predetermined intensity distribution which is dependent on a solid angle. The optical system can be used for homogenizing beam shaping for coherent or partially coherent laser sources and for radiation sources emitting in a narrow spectral region.

b) Description of the Related Art

Industrial and scientific use of laser radiation sources has increased enormously in scope and frequency in recent years. Important fields of application include material processing, medical engineering, the semiconductor industry, and measuring technology. The laser beam is used, e.g., as a tool for ablating material, for defined illumination, or for detecting physical parameters. One reason for the broad application of lasers consists in the physical characteristic of the laser radiation itself which is distinguished by excellent collimating capability and focusing, a narrow band and coherence.

In spite of these advantages, it is necessary in most applications to modify the radiation emitted by the laser through suitable optics. This is especially true when the intensity distribution required in the application deviates from the beam of the laser that is used, e.g., with respect to its spatial extension or divergence, its intensity profile or homogeneity.

For example, it is necessary in certain applications to convert input radiation with an asymmetric and inhomogeneous intensity profile such as is emitted, e.g., by excimer lasers into a homogeneous intensity distribution with a predetermined intensity profile in a determined plane. Homogeneous intensity distributions of this kind are required, for example, for material processing or for illumination in lithography installations.

It is known that lens array arrangements are suitable for homogenizing laser radiation, particularly of excimer laser radiation (DE 42 20 705 A1, DE 102 25 674 A1, DE 196 32 460 C1). Such arrangements work efficiently and intensity profiles with good homogeneity can be realized.

However, a substantial limitation of lens array homogenizers consists in that they cannot be used to realize any desired intensity distributions such as ring-shaped or star-shaped distributions.

On the other hand, diffractive optical elements which modify a radiation field in a specific manner through complex changes in amplitude and phase by means of a computer-generated diffracting structure are suitable for providing variously shaped intensity distributions (Gerchberg, R. W. and Saxton, W. O. (1972) “A practical algorithm for the determination of phase from image and diffraction plane pictures”, Optics 35, 237-246; Wyrowski, F. and Bryngdahl, O. (1988” “Iterative Fourier-transform algorithm applied to computer holography”, J. Opt. Soc. Am. 5, 1958-1966; Turunen, J. and Wyrowski, F. eds. “Diffractive Optics for Industrial and Commercial Applications”, Akademie Verlag, Berlin, (1997)).

Diffractive optical elements of the kind mentioned above acting as diffractive homogenizers advantageously comprise different individual facets which redistribute the radiation energy based on their individual diffracting properties (U.S. Pat. No. 4,547,037).

A disadvantage of diffractive structures is their susceptibility to manufacturing deviations in the surface profile of the calculated reference profile. In particular, deviations in the profile depth and duty factor result in an occasionally disruptive increase in intensity due to the zeroth diffraction order which corresponds to the proportion of radiation which passes through the diffractive element without being diffracted and forms a bright punctiform area, or “hot spot”, in the center of a two-dimensionally distributed radiation intensity.

The occurrence of a hot spot of this kind has a progressively disruptive effect as a surface that is to be irradiated homogeneously increases, since the ratio of the light intensity of this hot spot to the light intensity of its homogeneously illuminated surroundings depends on the profile deviation of the diffractive structure on the one hand and on the numerical aperture of the optical diffraction element on the other hand.

Consequently, diffractive homogenizers with an identical deviation from profile depth and duty factor but with a higher numerical aperture have hot spots whose light intensity is greater compared to the light intensity of their homogeneously illuminated surroundings.

Since the ratio of the intensity of the hot spot to the total intensity of the input beam can only be minimized within limits by technological means for increasing the accuracy of the produced diffractive structures, the use of the diffractive homogenizer with increasingly higher apertures frequently presents insurmountable difficulties.

Diffractive structures are known from U.S. Pat. No. 6,118,559 for reducing the zeroth diffraction order that occurs to an increased extent when using polychromatic radiation. These known diffractive structures have three height levels, two of which adjacent height levels generate a phase shift of π. The described structures are likewise suitable for reducing the influence of production-oriented profile depth errors with respect to the occurrence of the zeroth diffraction order, but not for preventing the influence of deviating duty factors.

Further, as the numerical aperture increases, smaller dimensions are required for the diffractive structures so that the production of the three-stage height profiles is subject to technological limits, although binary structures may still be manufactured within these limits.

### OBJECT AND SUMMARY OF THE INVENTION

Therefore, it is the primary object of the invention while making use of the advantages of diffractive structures in providing variously shaped intensity distributions to reduce the disruptive influence of the zeroth diffraction order beyond the limits imposed by the manufacturing accuracy in the manufacture of the diffractive structures, also with increasingly higher apertures.

According to the invention, this object is met in that an optical system for converting a primary intensity distribution into a predetermined intensity distribution dependent on a solid angle contains first micro-optic homogenization structures which generate a finely structured amplitude distribution and phase distribution from the primary intensity distribution in a first plane, second diffractive micro-optic homogenization structures which are arranged in the first plane so as to be adapted to the finely structured amplitude distribution and phase distribution and which generate the predetermined solid angle-dependent intensity distribution in a second plane from the finely structured amplitude distribution and phase distribution.

It is especially important that the first and second micro-optic homogenization structures are adapted to one another so that the desired intensity distribution can be generated in a spatially dependent manner.

The suppression of the disruptive influence of the zeroth diffraction order and the shaping of any desired intensity distributions is ensured in that the second micro-optic homogenization structures are designed as diffractive structures and are arranged in the first plane located in the near field of the first micro-optic homogenization structures.

The first and second micro-optic homogenization structures can advantageously be arranged on opposite surfaces of a common optical carrier. But surfaces of two adjacent optical carriers which face one another can also be used.

In a preferred embodiment, the first micro-optic homogenization structures are constructed as diffractive structures which can have at least two height levels or can have a blazed profile. Structures with diffracting characteristics which impress a phase structure on the primary input wave so that the desired intensity distribution is formed in the wave propagation are used in particular.

The second diffractive micro-optic homogenization structures can also have two or more height levels or can have a blazed profile.

The two micro-optic homogenization structures can also be gradient index modulated.

In a special construction of the invention, the micro-optic homogenization structures are constructed in a facet-shaped manner and the diffractive structures of different facets differ from one another.

The facets can be formed regularly, but should advantageously have an irregular shape. In particular, arrangements in which facets varying in shape and/or size cover the entire surface can be selected. This has the advantage that there is no pattern formation due to possible interference such as with a periodic grating, even when there is only a partial coherence.

As an alternative to constructing the first micro-optic homogenization structures as diffractive binary structures as mentioned above, they can also be constructed as a refractive lens array arrangement.

Since refractive lens arrays can be constructed in such a way that they do not generate an excessive central increase in intensity like a zeroth diffraction order, the entire system contains at most a proportion of a zeroth diffraction order of the second diffractive micro-optic homogenization structures so that a reduction in the interference component compared to the use of an individual diffractive structure can also be achieved in this case without having to dispense with the advantageous characteristics of the diffractive structures.

A further object of the invention is a method for converting a primary intensity distribution into a predetermined intensity distribution that is dependent on a solid angle by generating first diffractive homogenization structures which generate a finely structured amplitude distribution and phase distribution from the primary intensity distribution in a first plane, and by generating second diffractive homogenization structures which are adapted to the finely structured amplitude distribution and phase distribution of the first plane and by means of which the finely structured amplitude distribution and phase distribution are converted into the predetermined solid angle-dependent intensity distribution in a second plane.

The first micro-optic homogenization structures not only generate the finely structured amplitude distribution and phase distribution in the first plane but also generate an intensity distribution in the second plane which extends over a solid angle region which deviates from the solid angle region comprehended by the total system of the first and second micro-optic homogenization structures.

The intensity distribution that is generated by the first micro-optic homogenization structures in the second plane advantageously has a Gaussian shape and extends over a solid angle region that is smaller than the solid angle region comprehended by the total system of the first and second micro-optic homogenization structures.

The invention will be described more fully in the following with reference to the schematic drawings.

### BRIEF DESCRIPTION OF THE DRAWINGS

In the drawings:

FIG. 1a shows a schematic view of the micro-optic homogenization structures arranged on an optical carrier;

FIG. 1b shows a schematic view of the micro-optic homogenization structures arranged on two adjacent optical carriers;

FIG. 2 shows the intensity distribution during beam shaping with first micro-optic homogenization structures and with first and second micro-optic homogenization structures;

FIG. 3a shows the zeroth diffraction order protruding from the intensity profile when using only one micro-optic homogenization structure whose surface profile deviates from the reference profile;

FIG. 3b shows the effect that can be achieved by combining two micro-optic homogenization structures with respect to the occurrence of the zeroth diffraction order when the second micro-optic homogenization structure has a profile error comparable to that in the arrangement with only one homogenization structure in FIG. 3a;

FIG. 3c shows the intensity profile in an arrangement according to the invention in which the two micro-optic homogenization structures have a defective profile;

FIG. 4 shows a preferred embodiment form with two micro-structured quartz substrates whose structured surfaces lie opposite one another; and

FIG. 5 shows facet elements and an enlarged section of two facet elements.

### DESCRIPTION OF THE PREFERRED EMBODIMENTS

Homogenizing and/or beam-shaping micro-optic structures, designated for the sake of simplicity as micro-optic homogenization structures 1, 2, are used according to the invention.

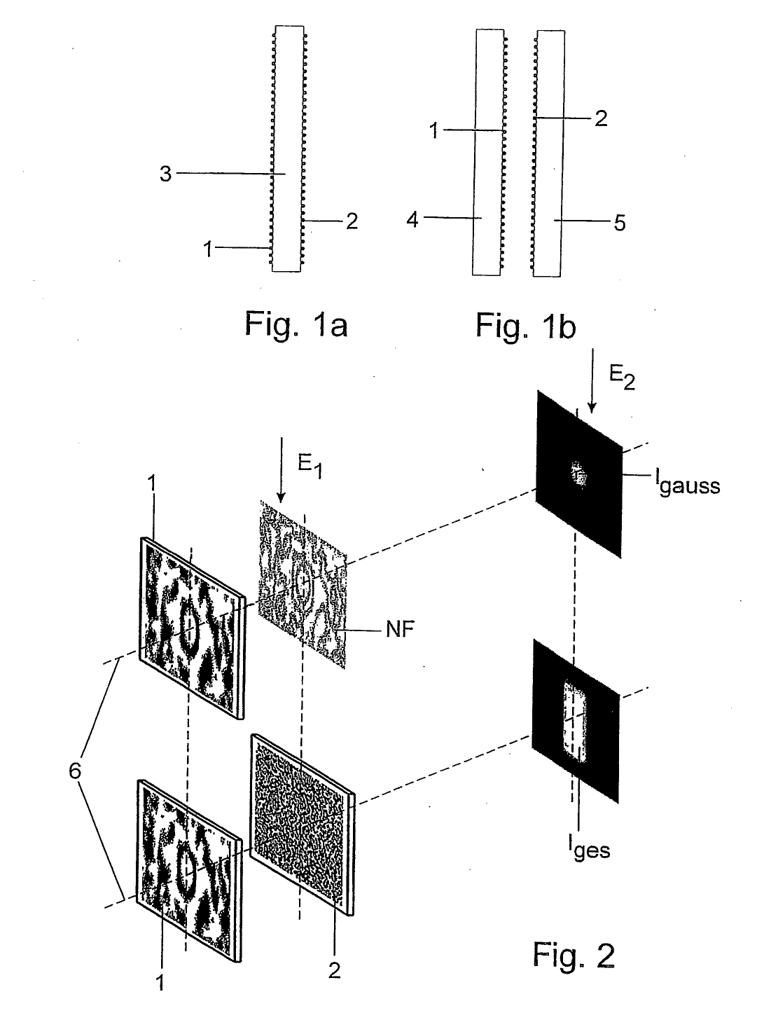

The micro-optic homogenization structures 1, 2 which are arranged in succession can either be arranged on a transparent plate-shaped optical carrier 3 on opposite lateral surfaces (FIG. 1a) or two transparent plate-shaped optical carriers 4, 5 can be arranged adjacent to one another and their surfaces that face one another can have the micro-optic homogenization structures 1, 2 (FIG. 1b).

The micro-optic homogenization structures 1, 2 can contain diffractive binary structures or diffractive structures with a plurality of height levels or refractive structures with a continuous height profile, e.g., lens array arrangements. Therefore, the surfaces of the transparent optical carriers 3-5 can have diffractive structures or diffractive and refractive structures are combined in that a first carrier surface contains a refractive lens array arrangement and a second carrier surface contains diffractive structures. The micro-optic homogenization structures 1, 2 are preferably phase structures but can also be amplitude structures.

According to the invention with reference to FIG. 2, a desired optical characteristic is imparted to a shaping and/or homogenizing input beam 6 with a primary intensity distribution by a combined cooperation of the two micro-optic homogenization structures 1, 2. To this end, the first micro-optic homogenization structures 1 are constructed in such a way that a determined, e.g., diffuse Gaussian, intensity distribution I_{gauss} which preferably extends over a smaller solid angle region than the solid angle region defined by the total system of the two micro-optic homogenization structures 1, 2 is generated in the far field (second plane E₂).

By the far field of the micro-optic homogenization structures 1, 2 is meant that region behind the micro-optic homogenization structures 1, 2 in which the solid angle-dependent intensity distribution no longer changes as the distance increases. In many applications, it is advantageous to image the intensity distribution of the far field with a collecting lens positioned directly behind the two homogenization structures. The second micro-optic homogenization structures 2 are directly downstream of the first micro-optic homogenization structures 1 in the near field (first plane E₁), i.e., they are located in a region directly behind the first micro-optic homogenization structures 1 in which the essential features of the far-field intensity distribution generated by the first micro-optic homogenization structures 1 are still not detectable. But the first micro-optic homogenization structures 1 generate, as a near-field distribution NF, a fine structure with an amplitude distribution and phase distribution with respect to which the second micro-optic homogenization structures 2 which are tailored to this distribution in design by computer generation must be adjusted exactly in order to obtain the required quality of the desired intensity distribution of the total system I_{ges} of the first and second micro-optic homogenization structures 1, 2 with respect to edge steepness and homogeneity.

The closely adjacent arrangement of the two micro-optic homogenization structures 1, 2 is necessary because as the distance increases the sensitivity to changes in the angle of incidence increases. A mutual adjustment in case of an input beam containing an angular spectrum (e.g., in arrangements with excimer lasers) would no longer be possible at too great a distance.

Further, it is necessary for a high efficiency to process, if possible, all of the energy conveyed by the first micro-optic homogenization structures 1. If the distance between the two micro-optic homogenization structures 1, 2 increases and a high aperture is desired, a correspondingly large surface would be required for the second micro-optic homogenization structures 2 which would result in higher cost.

The boundary along which the two micro-optic homogenization structures 1, 2 can be arranged adjacent to one another is determined by the geometric shape (bending, wedge error, etc.) of the optical carriers 3-5 on whose surfaces the micro-optic homogenization structures 1, 2 are arranged.

The disruptive influence of the zeroth diffraction order which can be caused, for example, by errors in the manufacture of diffractive micro-optic homogenization structures is substantially minimized by the invention.

For example, when the surface profile of the second micro-optic homogenization structures 2 has deviations from the ideal profile determined by design which are caused by manufacturing errors, the second micro-optic homogenization structures 2 will pass a certain proportion of the incident radiation without diffraction. However, since this proportion already contains the angular spectrum generated by the first micro-optic homogenization structures 1, a proportion of the diffuse Gaussian distribution I_{gauss} generated by the first micro-optic homogenization structures 1 would have to be added to the homogeneous intensity distribution I_{ges} formed by the total system in a construction corresponding to FIG. 2. Compared to an arrangement containing only first diffractive micro-optic homogenization structures 1, the undiffracted proportion of the zeroth diffraction order is distributed to a substantially larger surface and is therefore much less noticeable.

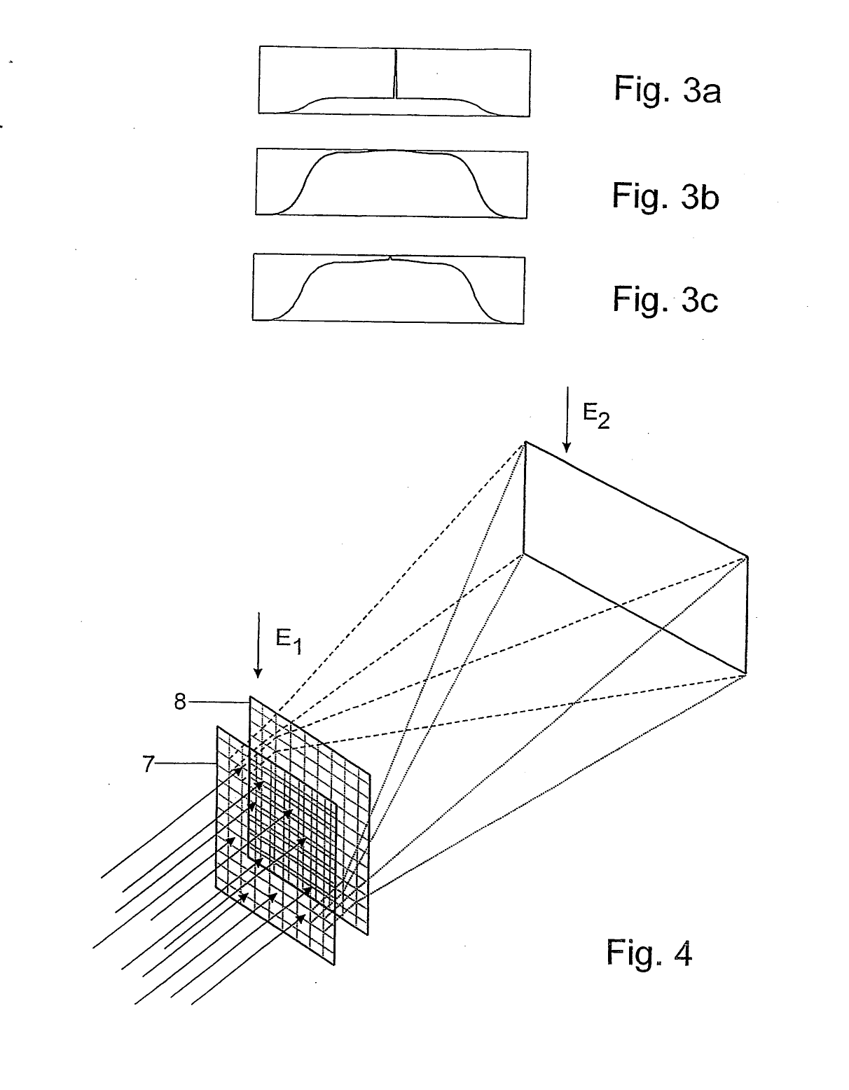

FIGS. 3a, 3b illustrate the difference between intensity profiles when an arrangement containing only first diffractive micro-optic homogenization structures 1 (FIG. 3a) is used and when, according to the invention, two diffractive micro-optic homogenization structures 1, 2 which are arranged one behind the other (FIG. 3b) are used, the profile deviations remaining the same.

Finally, FIG. 3c illustrates the result when both diffractive micro-optic homogenization structures 1, 2 have an identical defective profile resulting in a zeroth diffraction order, e.g., of 1%. The radiation component that passes both the first and the second micro-optic homogenization structures 1, 2 without diffraction must also be added to the intensity curve shown in FIG. 3b. This proportion has the angular spectrum of the primary beam but is then only 0.01%.

When the expected intensities of the zeroth diffraction orders are known and their light intensities are less than twice that of their surroundings, the excessive intensities shown in FIG. 3c can also be corrected by integrating corrective means for compensating for the anticipated excessive intensities into the second diffractive micro-optic homogenization structures 2, particularly into the element function. The corrective means can be constructed in such a way, for example, that the arrangement of the diffractive structures is modified so that the element function generates a compensating deviation from the reference profile.

This type of pre-correction is also possible in theory in the construction with a structure.

However, when the light intensity of the zeroth diffraction order is more than twice the ambient light intensity, for example, as in FIG. 3a, pre-correction is not possible.

FIG. 4 shows a preferred embodiment form of the invention in which the micro-optic homogenization structures 1, 2 are located on opposite surfaces of two adjacent quartz substrates 7, 8 which are arranged successively at a distance of a few micrometers.

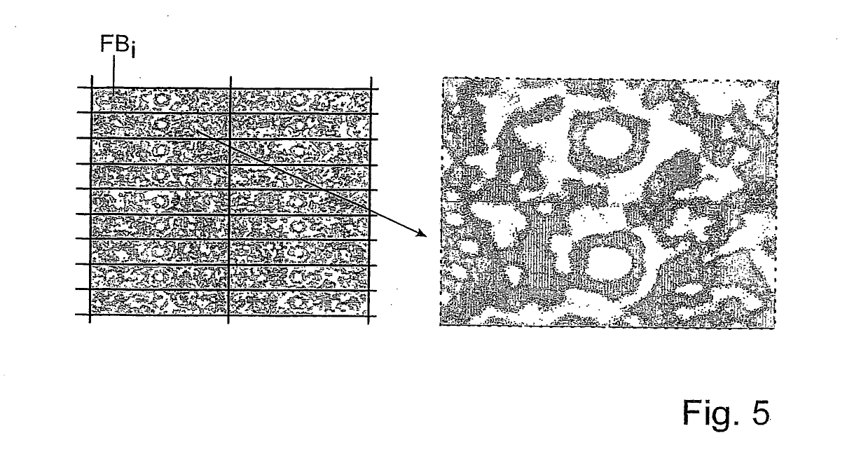

The two diffractive micro-optic homogenization structures 1, 2 are facetted according to the view shown in FIG. 5, wherein each facet region FBᵢ which is delimited in itself and contains the diffractive structures needed to realize the beam shaping must be converted into a predefined intensity distribution by the proportion of the incident beam. In the second plane E₂, all of the intensity distributions generated by the facet regions are superimposed and accordingly homogenized. It is important that the facet regions FBᵢ of the two adjacent quartz substrates 7, 8 are made to coincide in a highly accurate manner.

Since certain inhomogeneities with a fine structure or noise can be generated in an unwanted manner due to the diffractive structures in the shaped intensity distribution, it is particularly advantageous when each facet region FBᵢ is structured somewhat differently. Fine structures or noise components can accordingly be suppressed.

While the foregoing description and drawings represent the present invention, it will be obvious to those skilled in the art that various changes may be made therein without departing from the true spirit and scope of the present invention.

1-14. (canceled)

15. An optical system for converting a primary intensity distribution into a predetermined intensity distribution dependent on a solid angle comprising:
first micro-optic homogenization structures which generate a finely structured amplitude distribution and phase distribution from the primary intensity distribution in a first plane; and
second diffractive micro-optic homogenization structures which are arranged in the first plane so as to be adapted to the finely structured amplitude distribution and phase distribution and which generate the predetermined solid angle-dependent intensity distribution in a second plane from the finely structured amplitude distribution and phase distribution.

16. The optical system according to claim 15, wherein the first and second micro-optic homogenization structures are arranged on opposite surfaces of a common optical carrier.

17. The optical system according to claim 15, wherein the first and second micro-optic homogenization structures are arranged on surfaces of two adjacent optical carriers which face one another.

18. The optical system according to claim 15, wherein the first micro-optic homogenization structures are constructed as diffractive structures with at least two height levels.

19. The optical system according to claim 15, wherein the first micro-optic homogenization structures have a blazed profile.

20. The optical system according to claim 15, wherein the second diffractive micro-optic homogenization structures have at least two height levels or have a blazed profile.

21. The optical system according to claim 15, wherein the first and second micro-optic homogenization structures are gradient index modulated.

22. The optical system according to claim 18, wherein the micro-optic homogenization structures are constructed in a facet-shaped manner and the diffractive structures of different facets differ from one another.

23. The optical system according to claim 22, wherein facets varying in shape and/or size cover the entire surface.

24. The optical system according to claim 15, wherein the first micro-optic homogenization structures are constructed as a refractive lens array arrangement.

25. The optical system according to claim 15, wherein corrective means are integrated in the second diffractive micro-optic homogenization structures to compensate for the anticipated excessive intensities.

26. A method for converting a primary intensity distribution into a predetermined intensity distribution that is dependent on a solid angle comprising the steps of:
generating first diffractive homogenization structures which generate a finely structured amplitude distribution and phase distribution from the primary intensity distribution in a first plane; and
generating second diffractive homogenization structures which are adapted to the finely structured amplitude distribution and phase distribution of the first plane and by which the finely structured amplitude distribution and phase distribution are converted into the predetermined solid angle-dependent intensity distribution in a second plane.

27. The method according to claim 26, wherein an intensity distribution which extends over a solid angle region which deviates from the solid angle region comprehended by the total system of the first and second micro-optic homogenization structures is generated by the first micro-optic homogenization structures in the second plane.

28. The method according to claim 27, wherein the intensity distribution that is generated by the first micro-optic homogenization structures in the second plane has a Gaussian shape and extends over a solid angle region that is smaller than the solid angle region comprehended by the total system of the first and second micro-optic homogenization structures
